(19) United States
(12) Patent Application Publication
(10) Pub. No.: US 2008/0246608 A1
(43) Pub. Date: Oct. 9, 2008

(54) Multi-functional burglar-proof lockset assembly structure

(76) Inventor: Chen-Kuei Hsieh, Jhongli City (TW)

Correspondence Address: Troxell Law Office Pllc, Suite 1404, 5205 Leesburg Pike, Falls Church, VA, 22041, US

(21) Appl. No.: 11/783,281

(22) Filed: Apr. 6, 2007

(51) Int. Cl. B60R 25/02

(52) U.S. Cl. 340/568.1

(57) ABSTRACT

A multi-functional burglar-proof lockset assembly structure includes at least a lockset, a burglar-proof alarm circuit, and a personal alert device. The lockset body can be locked on a steering wheel to restrict rotation. When the lockset is locked, the burglar-proof alarm circuit in the lockset is activated to operate, and a detection end and a vibration sensor are activated, to detect a possible condition when a car is stolen, such as a change of atmospheric pressure, a movement of object, masking or interruption to an ultrasonic signal, fracturing to a glass, or abnormal vibration. In addition, an output signal is transmitted to a central processing unit for discrimination, and when a burglar-proof alert message is created, the burglar-proof alarm circuit can transmit the message to a user's personal alert device, thereby achieving functions of a long-range burglar-proof alert and a two-way remote control.

### BACKGROUND OF THE INVENTION

a) Field of the Invention

The present invention relates to a multi-functional burglar-proof lockset assembly structure, and more particularly to a multi-functional burglar-proof lockset assembly structure which is provided with a burglar-proof alarm circuit that can precisely detect bands in large range.

b) Description of the Prior Art

Many people are now configuring an electronic burglar-proof device or a mechanical burglar-proof lockset for their cars to secure them without being stolen. However, no matter using what kind of mechanical lockset that is precise, hard to unlock, robust, and hard to damage, or what kind of electronic burglar-proof device that senses precisely and is provided with multiple functions, it can only delay a carnapper to successfully steal the car, due to a brilliant stealing technique of the carnapper. Therefore, a complete burglar-proof effect cannot be truly achieved. As a matter of fact, it is not difficult to unlock or damage the lockset, as long as one has sufficient time and well-prepared equipment. Accordingly, an ideal and effective burglar-proof device should be both provided with the features of a mechanical lockset that is robust and hard to damage, and of a burglar-proof alert device that is precise and sensitive. Furthermore, when a thief is stealing the car, many different frequencies will be formed due to many different actions; therefore, when the electronic burglar-proof device is detecting a change of ambient condition, many sensors for detecting different bands should be used to detect different frequencies, and trigger the burglar-proof device. When an ordinary burglar-proof alarm is triggered, most of the time only alarm sound is sent out on the car. Therefore, unless a car owner happens to be near his or her car, the owner will not be able to be aware of that burglar-proof alarm signal to react in time. Accordingly, the alarm sound of conventional burglar-proof alarm can only deter a thief, and is not able to alert the car owner to take an action in time.

### SUMMARY OF THE INVENTION

The primary object of present invention is to provide a multi-functional burglar-proof lockset assembly structure, which is provided with a burglar-proof alarm circuit that can precisely detect bands in large range, and an automobile burglar-proof alarm lock that can be fitted with a personal alert device to inform a car owner in time, thereby being both equipped with a long-range burglar-proof alert function and a two-way remote-control function.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a block diagram of the present invention.

FIG. 3 shows a schematic view of an embodiment of the present invention.

FIG. 4 shows a block diagram of an embodiment of the present invention.

FIG. 5 shows a circuit diagram of the present invention.

FIG. 6 shows a flow diagram of the present invention.

FIG. 7 shows a second flow diagram of the present invention.

### DETAILED DESCRIPTION OF THE PREFERRED EMBODIMENTS

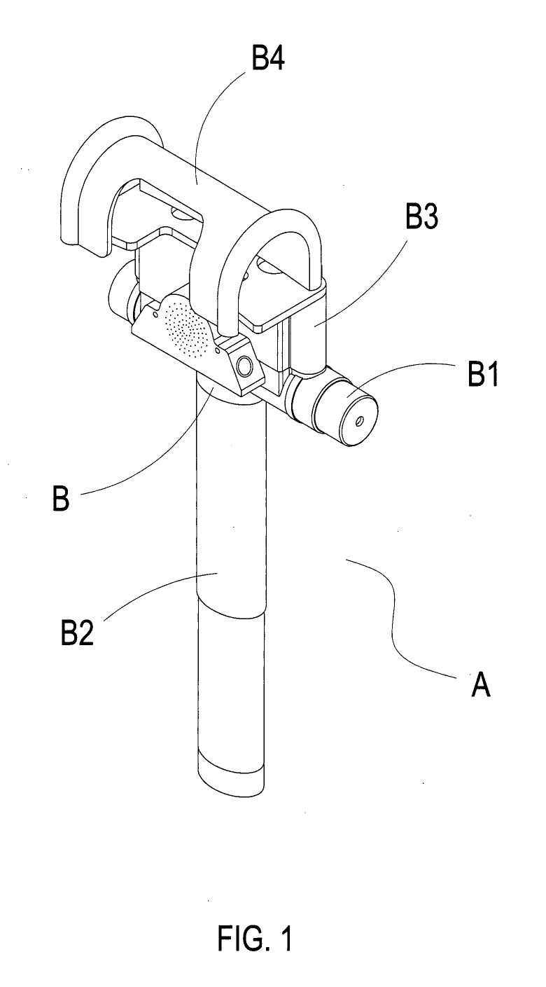

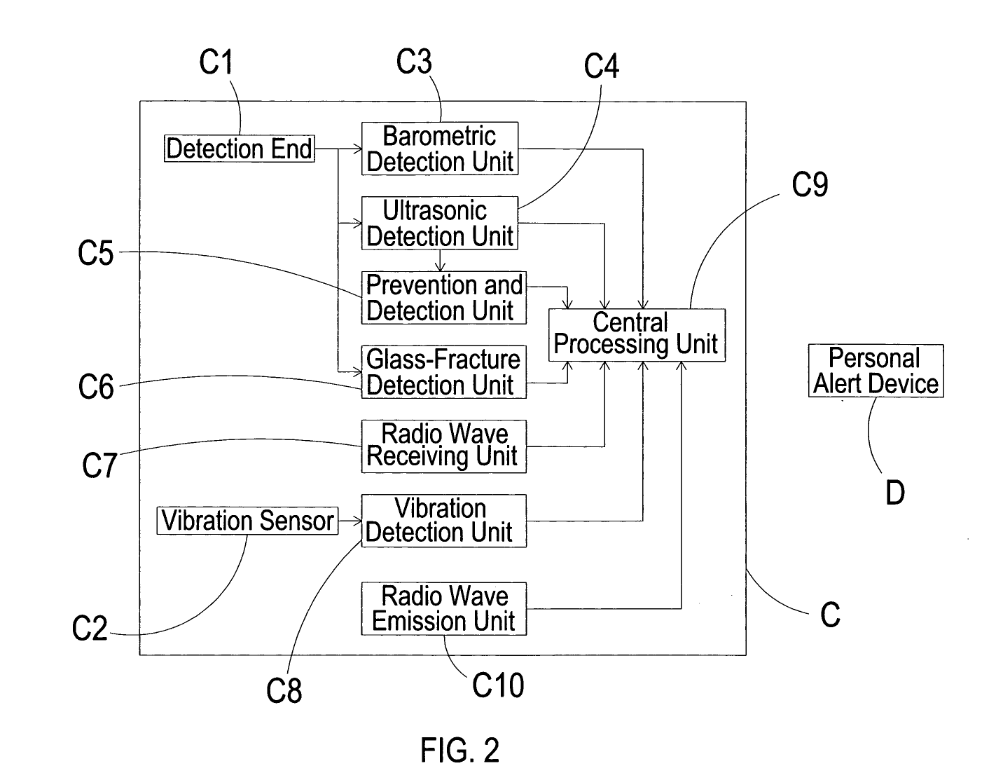

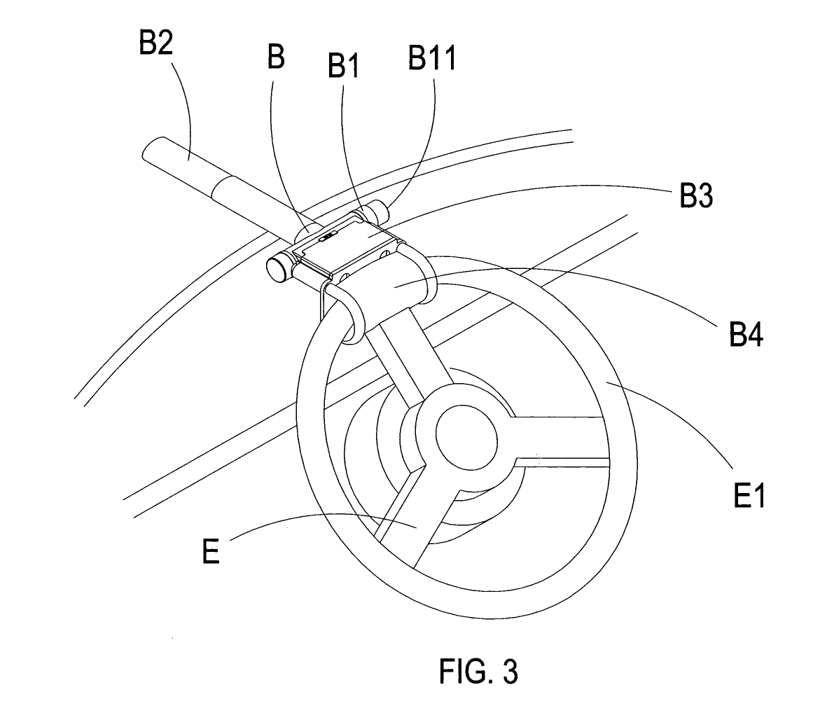

Referring to FIGS. 1 to 3, a burglar-proof lockset A is constituted by a lockset B, a burglar-proof alarm circuit C, and a personal alert device D. The lockset B is provided with a locking body B1 which can be opened or locked, and the locking body B1 is extended with a rod B2 and a locking seat B3. In addition, the locking seat B3 is extended with a locking sheath B4 which can be locked on a steering wheel, and an interior of the locking seat B3 is provided with the burglar-proof alarm circuit C which is extended with a detection end C1 that can detect frequencies in large range. A barometric detection unit C3, an ultrasonic detection unit C4, an ultrasonic signal prevention and detection unit C5, and a glass-fracture detection unit C6 of the burglar-proof alarm circuit C are electrically conducted through the detection end C1. In a mean time, a vibration detection unit C8 of the burglar-proof alarm circuit C is electrically conducted through a vibration sensor C2, and a signal is transmitted to a central processing unit C9 for discrimination, such that when a burglar-proof alert message is created, the burglar-proof alarm circuit C can use a radio wave emission unit C10 to send out a radio wave signal to the personal alert device D of a car owner. The personal alert device D can emit the radio wave signal to a radio wave receiving unit C7 of the burglar-proof alarm circuit C, to achieve functions of a long-range burglar-proof alert and a remote delay to alarm, enabling the burglar-proof lockset A to be provided with a burglar-proof function with multiple alerts and a function of prevention and detection, and to allow a user to take a necessary approach in time.

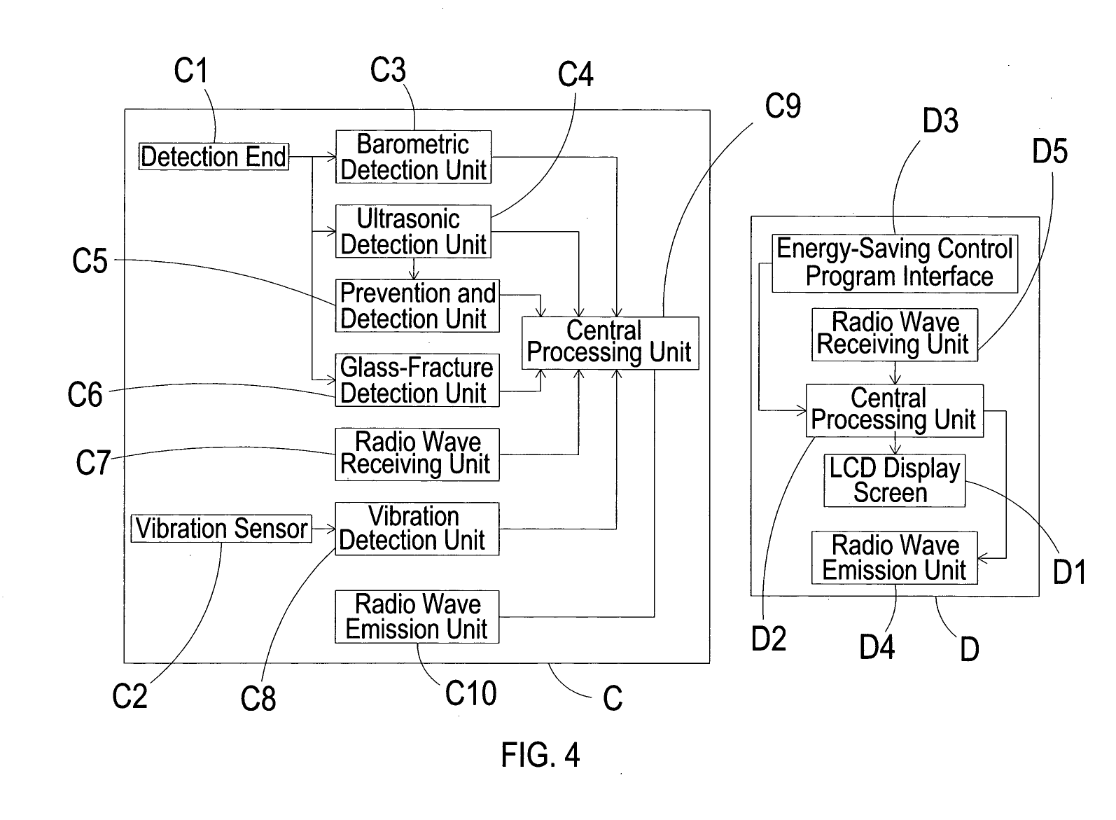

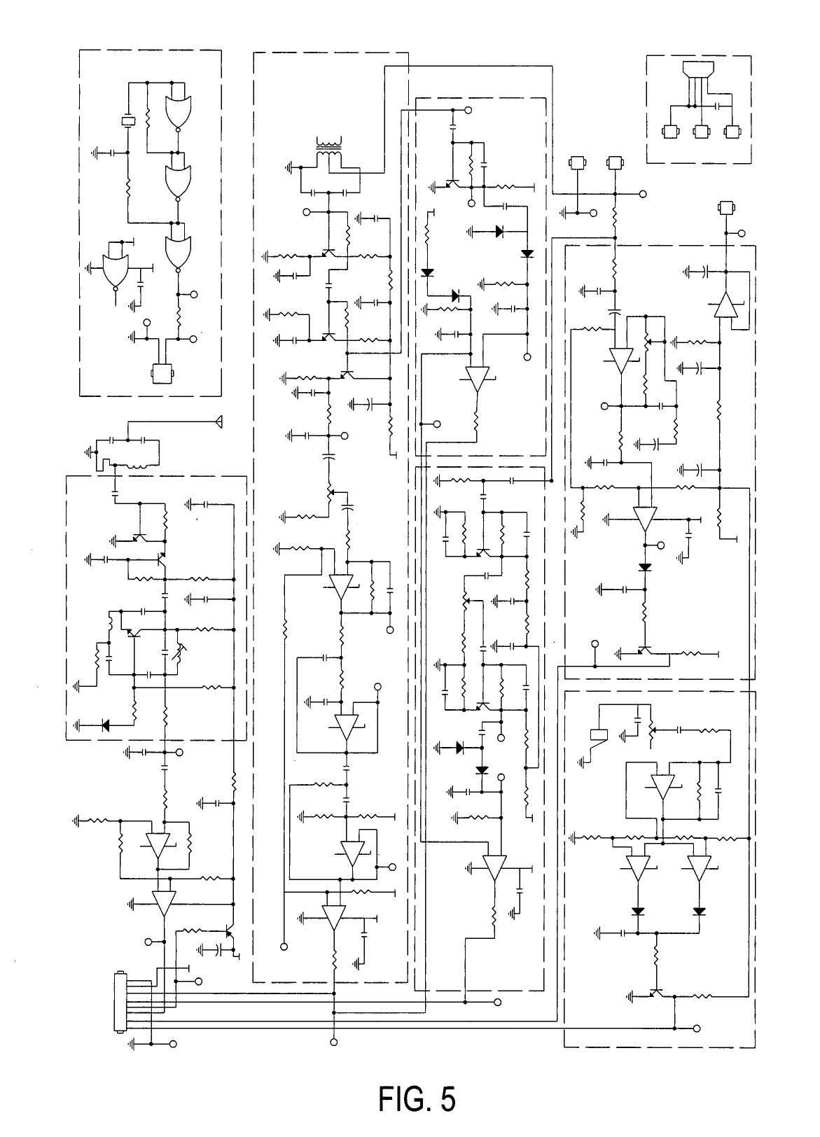

The present invention is to provide a multi-functional burglar-proof lockset assembly structure. Referring to FIG. 4 and FIG. 5, a burglar-proof lockset A is locked on a steering wheel E for burglar-proof alerting, and its lockset B is extended with a locking body B1. The locking body B1 is provided with a lock head B11 which can be opened or locked, and is extended with a rod B2 and a locking seat B3. The locking seat B3 is extended with a locking sheath B4 which can be locked on the steering wheel E. When the burglar-proof lockset A is to be locked on the steering wheel E, the locking sheath B4 is sheathed on a wheel ring E1 of the steering wheel E, and is locked on the locking seat B3; whereas, the rod B2 of the lockset B is extended on a driving panel, enabling the lockset B to be locked on the steering wheel E to restrict rotation of the steering wheel E and to burglar-proof and secure a car. When the lockset B is locked on the steering wheel E, a burglar-proof alarm circuit C inside the lockset B is activated as a same time. If, during a period of burglar-proof operation, the burglar-proof alarm circuit C detects that atmospheric pressure in the car changes momentarily, an object is moving in the car, an ultrasonic signal is masked or interrupted, a glass is fractured, or the car vibrates abnormally, then the burglar-proof alarm circuit C will send out strong burglar-proof alarm sound and intense flash to deter a thief. At a same time, when a burglar-proof alarm signal is created, it will be received and transmitted in two-way between the burglar-proof alarm circuit C and the personal alert device D through a two-way radio wave signal transmission and receiving unit, thereby achieving functions of a long-range burglar-proof alert and remote delay to alarm.

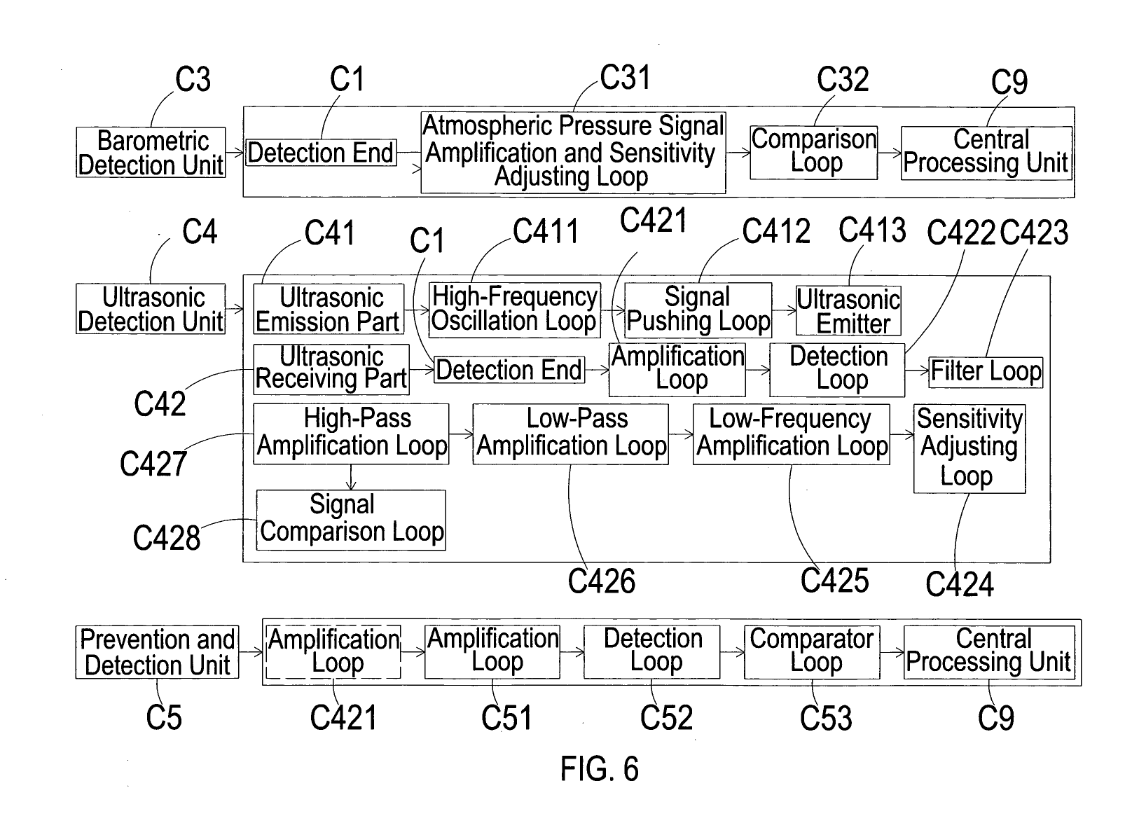

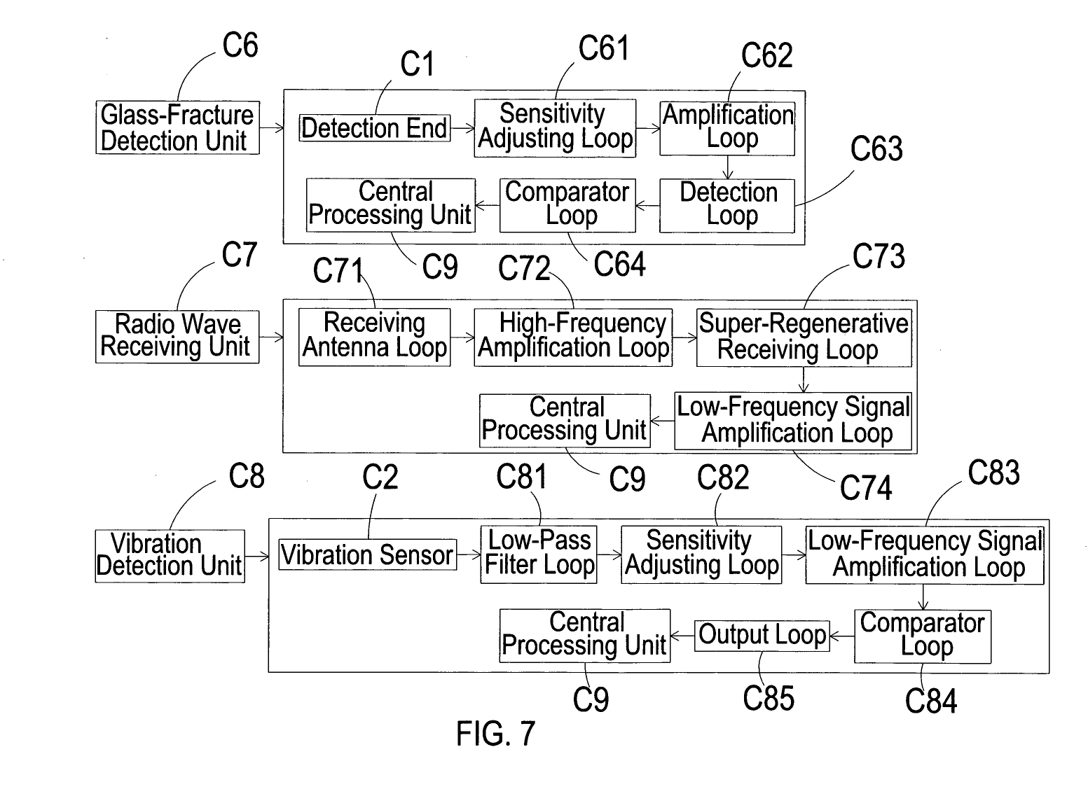

Referring to FIGS. 4 to 7, a detection end C1 of the burglar-proof alarm circuit C is a mechanical capacitor, mechanical piezoelectric, and semi-conductor microphone device, and can detect a change of frequency, such as the change of atmospheric pressure, the movement of an object, the fracturing of a glass, or that the ultrasonic signal is masked or interrupted. In the mean time, the vibration sensor C2 detects whether there is abnormal vibration, so as to facilitate the burglar-proof alarm circuit C to proceed with detection of frequencies in large range. Furthermore, the detection end C1 electrically conducts a barometric detection unit C3, an ultrasonic detection unit C4, an ultrasonic signal prevention and detection unit C5, and a glass-fracture detection unit C6 of the burglar-proof alarm circuit C; whereas, the vibration sensor C2 electrically conducts a vibration detection unit C8.

The barometric detection unit C3 which operates by a signal of change of atmospheric pressure includes an atmospheric pressure signal amplification and sensitivity adjusting loop C31 and a comparison loop C32, wherein a pressure detection loop of the atmospheric pressure amplification and sensitivity adjusting loop C31 can detect a momentary change of air pressure in the car, and transform a monitored message into an electronic signal which is processed by the comparison loop C32 and is then transmitted to the central processing unit C9 for discrimination, thereby effectively detecting the change of atmospheric pressure in the car.

The ultrasonic detection unit C4 which operates by a signal of object movement includes an ultrasonic emission part C41 that sends out an ultrasonic signal to a space in the car, and an ultrasonic receiving part C42 for receiving the signal which is analyzed and processed and is then transmitted to the central processing unit C9 for discrimination. The ultrasonic emission part C41 is provided with a high-frequency oscillation loop C411, a signal pushing loop C412, and an ultrasonic emitter C413; whereas the ultrasonic receiving part C42 is provided with an amplification loop C421 which can amplify a reflection wave signal, a detection loop C422, a filter loop C423, a sensitivity adjusting loop C424, a low-frequency amplification loop C425, a low-pass amplification loop C426, a high-pass amplification loop C427, and a signal comparison loop C428.

The ultrasonic signal prevention and detection unit C5 which operates when the signal disappears is provided with an amplification loop C51, a detection loop C52, and a comparator loop C53, to output a signal level to the central processing unit C9 for discrimination, such that when the signal disappears, the signal can be outputted to the central processing unit C9 for discrimination.

The glass-fracture detection unit C6 which operates when a glass fractures is provided with a sensitivity adjusting loop C61, an amplification loop C62, a detection loop C63, and a comparator loop C64, such that when a car window fractures, a signal will be immediately outputted to the central processing unit C9 for discrimination; or when a thief uses a strong signal to interrupt, the glass-fracture detection unit C6 will also output the signal to the central processing unit C9 for discrimination.

The radio wave receiving unit C7 which operates by receiving a radio wave signal of the personal alert device D is provided with a receiving antenna loop C71, a high-frequency amplification loop C72, a super-regenerative receiving loop C73, and a low-frequency signal amplification loop C74, to receive the radio wave signal sent out by the personal alert device D. The radio wave signal is processed, and is then outputted to the central processing unit C9 for program decoding, so as to facilitate that when the car owner enters into the car, he or she can remotely configure a delay to alarm first.

The vibration detection unit C8 which operates when the vibration sensor C2 detects a vibration situation is provided with a low-pass filter loop C81, a sensitivity adjusting loop C82, a low-frequency signal amplification loop C83, a positive and negative signal level discrimination and comparison loop C84, and an output loop C85, such that when the car vibrates abnormally, a signal can be outputted to the central processing unit C9 for discrimination.

By the detection end C1 and the vibration sensor C2, many kinds of possible situation which occur when the car is stolen, can be detected, thereby improving an automobile burglar-proof effect by the burglar-proof lockset A.

The personal alert device D is provided with a loop of an LCD display screen D1, which is controlled by a central processing unit D2 to display the burglar-proof alert signal on the LCD display screen D1. The personal alert device D is also provided with an energy-saving control program interface D3 which can shutdown the LCD display screen D1 to save energy consumption.

The personal alert device D is provided with a radio wave emission unit D4 which can send out the radio wave signal to the burglar-proof alarm circuit C to match codes of the burglar-proof alarm circuit C and a program of the personal alert device D, or to remotely activate the burglar-proof alarm circuit C to enter into a procedure of delaying alarm. In addition, the personal alert device D is provided with a radio wave receiving unit D5, to receive and process the radio wave signal, and to output the processed signal to the central processing unit D2 for discrimination.

When the lockset B is locked, the burglar-proof alarm circuit C is activated, and a power-on signal is transmitted by the radio wave emission unit C10. After the radio wave receiving unit D5 of the personal alert device D receives the power-on code, the power-on reaction will be active and the personal alert device D will be in the power-on state. In addition, after the burglar-proof alarm circuit C further executes a delay procedure, a burglar-proof alerting state will be active. If the detection end C1 and the vibration sensor C2 of the burglar-proof alarm circuit C are triggered, timed alarm flashing and sounding will be immediately executed. In a mean time, the radio wave emission unit C10 will transmit the signal to the radio wave receiving unit D5 of the personal alert device D, and conditions of the car will be displayed on the LCD display screen D1, enabling the detection end C1 and the vibration sensor C2 to achieve a burglar-proof function with multiple alerts and a function of ultrasonic signal prevention, as well as to allow a user to take a necessary approach in time, through the burglar-proof alarm circuit C.

In order to further manifest the advancement and the practicability of the present invention, the advantages thereof are listed below:
1. It can detect frequencies in multiple bands.
2. A quantity of the detection ends can be decreased.
3. Multiple kinds of factors that a car is stolen can be detected, and a detection effect can be improved.
4. Cost can be reduced.
5. A user can be notified immediately by the personal alert device.
6. Conditions of the car can be available through the personal alert device.
7. It is provided with industrial competitiveness.
8. It is provided with value of business utilization.
9. It is provided with novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multi-functional burglar-proof lockset assembly structure, wherein the burglar-proof lockset includes a lockset, which is locked on a wheel ring of a steering wheel, and activates a function of burglar-proof alarm at a same time when the lockset is locked; a burglar-proof alarm circuit, which is contained in the lockset, is activated in corresponding to the locking of the lockset, and proceeds with a detection of a change of reflection wave frequency, a detection of abnormal fracture of a glass, and a prevention and detection of an ultrasonic signal, through a detection end and a central processing unit; and a personal alert device, which is provided with a programmable central processing unit, and alternately receives and transmits a signal between the burglar-proof alarm circuit through a radio wave signal emission and receiving unit, when the lockset is locked and activated and when a burglar-proof alert message is created; through the burglar-proof alarm circuit that precisely detects and a detection end that detects bands in large range, and through the personal alert device, a long range burglar-proof alert and a function of remote delay to alarm being achieved, enabling the detection end and a vibration sensor to achieve a burglar-proof function with multiple alerts and a function of ultrasonic signal preventing and detecting, and allowing a user to take a necessary approach in time, through the burglar-proof alarm circuit.

2. The multi-functional burglar-proof lockset assembly structure according to claim 1, wherein the burglar-proof alarm circuit includes further the vibration sensor for detecting a vibration state.

3. The multi-functional burglar-proof lockset assembly structure according to claim 1, wherein the lockset is provided with a locking body, a rod, a locking seat, and a locking sheath; when the locking sheath being locked on a wheel ring of a steering wheel and being locked on the locking seat, the burglar-proof alarm circuit being activated at a same time to proceed with a function of detecting and burglar-proofing.

4. The multi-functional burglar-proof lockset assembly structure according to claim 1, wherein the detection end is a mechanical capacitor, mechanical piezoelectric, and semi-conductor microphone device, enabling the burglar-proof alarm circuit to detect frequencies in large range.

5. The multi-functional burglar-proof lockset assembly structure according to claim 1, wherein the burglar-proof alarm circuit further includes the vibration sensor, and a vibration detection unit which is connected to the burglar-proof alarm circuit through the vibration sensor; the vibration detection unit being composed of a filter loop, a sensitivity adjusting loop, an amplification loop, a comparator loop, and an output loop, to output a signal to the central processing unit for discrimination.

6. The multi-functional burglar-proof lockset assembly structure according to claim 1, wherein the burglar-proof alarm circuit is provided with a barometric detection unit which operates by a signal of momentary change of atmospheric pressure; the barometric detection unit being composed of an atmospheric pressure signal amplification and sensitivity adjusting loop, and a comparison loop, to process a signal and then to transmit the processed signal to the central processing unit for discrimination, enabling the burglar-proof alarm circuit to effectively detect the momentary change of atmospheric pressure in a car.

7. The multi-functional burglar-proof lockset assembly structure according to claim 1, wherein the burglar-proof alarm circuit is provided with an ultrasonic detection unit which operates by a signal of object movement and which is composed of an ultrasonic emission part and an ultrasonic receiving part, to analyze and process a signal and to transmit the processed signal to the central processing unit for discrimination.

8. The multi-functional burglar-proof lockset assembly structure according to claim 7, wherein the ultrasonic emission part is provided with a high-frequency oscillation loop, a signal pushing loop, and an ultrasonic emitter, to send out an ultrasonic signal to a space in the car.

9. The multi-functional burglar-proof lockset assembly structure according to claim 7, wherein the ultrasonic receiving part is provided with an ultrasonic receiver, an amplification loop, a detection loop, a filter loop, a low-frequency amplification loop, a low-pass amplification loop, a high-pass amplification loop, and a signal comparison loop, to receive an ultrasonic signal, to proceed with analysis and processing, and to transmit the processed signal to the central processing unit for discrimination.

10. The multi-functional burglar-proof lockset assembly structure according to claim 1, wherein the burglar-proof alarm circuit is provided with a radio wave receiving unit which is composed of a receiving antenna loop, a high-frequency amplification loop, a super-regenerative receiving loop, and a low-frequency signal amplification loop, to receive a radio wave signal, to proceed with processing, and to output the processed signal to the central processing unit for discrimination.

11. The multi-functional burglar-proof lockset assembly structure according to claim 1, wherein the burglar-proof alarm circuit is provided with a radio wave emission unit having a program coding module, a modulation loop, a baseband oscillation loop, a double-band loop, a band-pass filter loop, and a power amplifier, to output a radio wave signal which is modulated.

12. The multi-functional burglar-proof lockset assembly structure according to claim 1, wherein the burglar-proof alarm circuit is provided with a prevention and detection unit which is composed of an amplification loop, a filter loop, and a comparator loop, such that when an ultrasonic detection signal disappears, an signal is outputted to the central processing unit for discrimination, thereby achieving a function of self loop-detection when the detection unit malfunctions or the signal disappears.

13. The multi-functional burglar-proof lockset assembly structure according to claim 1, wherein the burglar-proof alarm circuit is provided with a glass-fracture detection unit which is composed of a sensitivity adjusting loop, an amplification loop, a detection loop, and a comparator loop, to output a signal to the central processing unit for discrimination; when the alarm circuit being counter-measured or interrupted by a strong signal, a signal also being outputted to the central processing unit for discrimination.

14. The multi-functional burglar-proof lockset assembly structure according to claim 1, wherein the personal alert device is provided with a loop of an LCD (Liquid Crystal Display) display screen, which is controlled by a central processing unit to display a burglar-proof alert signal on the LCD (Liquid Crystal Display) screen.

15. The multi-functional burglar-proof lockset assembly structure according to claim 1, wherein the personal alert device is provided with an energy-saving control loop which allows the personal alert device to be under an energy-saving mode when the burglar-proof alarm circuit is power-on.

16. The multi-functional burglar-proof lockset assembly structure according to claim 1, wherein the personal alert device is provided with a radio wave emission unit having a high-frequency emission loop to emit a radio wave signal after being coded.

17. The multi-functional burglar-proof lockset assembly structure according to claim 1, wherein the personal alert device is provided with a radio wave receiving unit to receive a coded signal of a radio wave signal and to output the signal to the central processing unit for discrimination.
